(19) United States
(12) Patent Application Publication
(10) Pub. No.: US 2008/0238130 A1
(43) Pub. Date: Oct. 2, 2008

(54) Windshield With Incorporated Message Holder

(75) Inventors: Bruce Simmons, Rincon, GA (US); Charles Greif, Aiken, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/691,110

(22) Filed: Mar. 26, 2007

(51) Int. Cl. B60J 1/00

(52) U.S. Cl. 296/79

(57) ABSTRACT

A window assembly cooperating with a window frame on a golf car includes a first window pane coupled to the window frame. The first window pane defines a lower portion arranged adjacent to a body of the golf car. A message holder is disposed on the lower portion of the first window pane. The message holder according to one embodiment is integrally formed with the first window pane and is adapted to removably accept a message therein. The message holder according to another embodiment is fixedly coupled to the first window pane.

### FIELD

The present disclosure relates to golf cars and more specifically to a message holder incorporated on a front windshield assembly for a golf car.

### BACKGROUND

Golf cars provide transportation for golfers around a golf course. In addition, a golf car must also securely carry a golf bag in a location for convenient access throughout a round of golf. Many golf cars are equipped with a front windshield assembly for providing a transparent barrier to the passengers of the golf car. A front windshield can protect the passengers from weather, debris, and other objects such as insects and golf balls, for example. In one arrangement, a front windshield assembly is attached between a pair of upwardly extending struts arranged on a front end of the golf car. The struts define a window frame and typically connect with a roof structure of the golf car. In other arrangements, the window frame may be free standing at an upper end.

In some arrangements, a message holder may be attached near the roof structure. Such message holders typically are plastic and have an open end for receiving a message. Messages can include such information as golf pairings, pin placements, cart path rules, clubhouse menus and other information. While such message holders are generally useful for their intended purpose, a need exists to provide a more convenient and durable message holder.

### SUMMARY

A window assembly cooperating with a window frame on a golf car includes a first window pane coupled to the window frame. The first window pane defines a lower portion arranged adjacent to a body of the golf car. A message holder is disposed on the lower portion of the first window pane. The message holder according to one embodiment is integrally formed with the first window pane and is adapted to removably accept a message therein.

According to additional features, the message holder can define a pocket having at least one open end. The pocket can define a first transparent portion laterally offset from the first window pane. The first transparent portion further defines a pair of laterally offset terminal edges. Cutaway portions can be defined at the offset terminal edges for facilitating access to the message during installation and removal of the message.

The pocket can further comprise a third transparent portion extending between the first window portion and the first transparent portion. The third transparent portion can be generally parallel to the second transparent portion.

According to another example, the message holder can be fixedly coupled to a lower portion of the first window pane. The message holder can be fixedly coupled to the first window portion by fasteners and/or adhesive.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a portion of an exemplary golf car having a window assembly incorporating a message holder according to the present teachings;

FIG. 2 is an enlarged perspective view of the message holder shown with an exemplary message prior to placement within the message holder;

FIG. 3 is a sectional view of the windshield assembly taken through the message holder along line 3-3 of FIG. 1 and shown with the upper window pane in an upright position;

FIG. 4 is the sectional view of the windshield assembly taken through the message holder as depicted in FIG. 3 but shown with the upper window pane in a collapsed position;

FIG. 5 is an exploded partial perspective view of a message holder according to additional features;

FIG. 6 is an enlarged partial perspective view of the message holder of FIG. 5 shown fixedly attached to the window pane;

FIG. 7 is an exploded partial perspective view of a message holder according to additional features; and

FIG. 8 is a cross-sectional view of the message holder taken along line 8-8 of FIG. 7.

### DETAILED DESCRIPTION OF EXEMPLARY EMBODIMENTS

The following description of the preferred embodiment(s) is merely exemplary in nature and is in no way intended to limit the disclosure, its application, or uses.

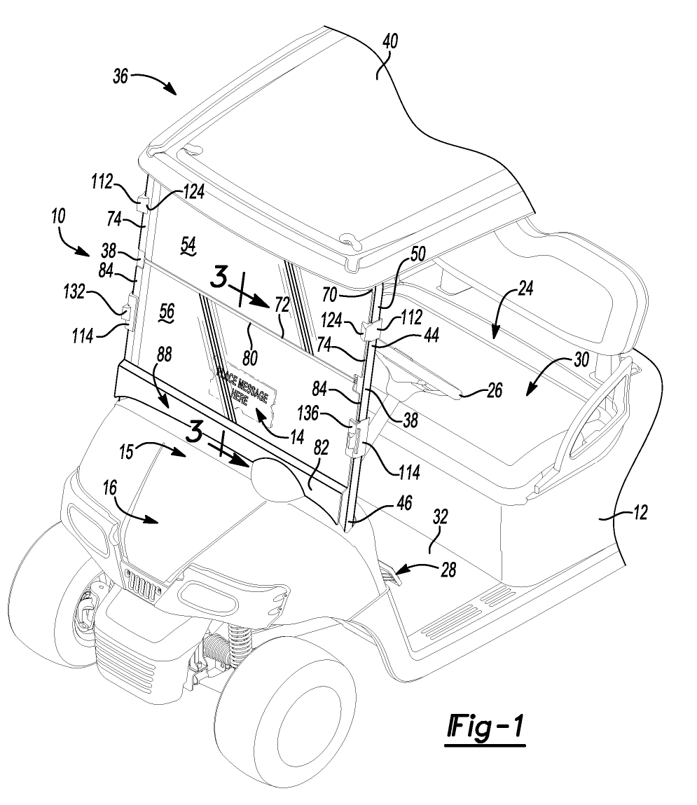

With initial reference to FIG. 1, a windshield assembly constructed in accordance to the present teachings is shown and identified generally at reference 10. As will be described in greater detail, the windshield assembly 10 is mounted to an exemplary golf car 12 and includes a message holder 14. Prior to describing the message holder 14, a brief description of the golf car 12 and windshield assembly 10 is warranted.

The windshield assembly 10 is illustrated operably connected to an exemplary golf car 12. It is appreciated that the golf car 12 is merely exemplary and that the windshield assembly 10 may be adapted for use with other golf car configurations. The golf car 12 can generally include a body 15 having a front end 16, a rear end (not particularly shown), and a passenger seating area 24. The passenger seating area 24 may include a steering wheel 26, accelerator and brake pedals 28, a seat 30, and a floor portion 32. The golf car 12 can additionally include an overhead assembly 36. The overhead assembly 36 generally includes a pair of front struts 38 supporting the windshield assembly 10. The overhead assembly 36 may be interconnected between the front end 16 of the golf car 12 and a roof portion 40. A pair of rear struts (not particularly shown) can extend between the rear end of the golf car 12 and the roof portion 40. The overhead assembly 36 provides protection for the vehicle passengers from the sun, but in some embodiments can protect against weather, debris, and other objects.

The pair of front struts 38 collectively define a window frame 44. A lower end 46 of the window frame 44 may be secured mechanically to the front end 16 of the golf car 12 such as by conventional fasteners (not shown). An upper end 50 of the window frame 44 may likewise secure mechanically to the roof 40 of the golf car 12. It is appreciated that alternatively, the front struts 38 and the rear struts may be integrally formed and collectively define an intermediate frame (not shown) extending along an underside of the roof 40. Other fastening arrangements for the upper end 50 and the lower end 46 of the window frame 44 are also contemplated. The lower end 46 of the window frame 44 can define a curved portion for cooperating with the geometry of the front end 16 of the golf car 12. The window frame 44 may be comprised of a rigid material such as metal or plastic.

The windshield assembly 10 includes a first or upper window pane 54, and a second or lower window pane 56. The upper window pane 54 defines a planar section. The upper window pane 54 is removably secured to the window frame 44 and arranged adjacent to the roof portion 40. The upper window pane 54 defines a top lateral edge 70, a bottom lateral edge 72, and a pair of side edges 74. The bottom lateral edge 72 is further defined by a curved flange 76. The curved flange 76 provides additional structural support to the upper window pane 54.

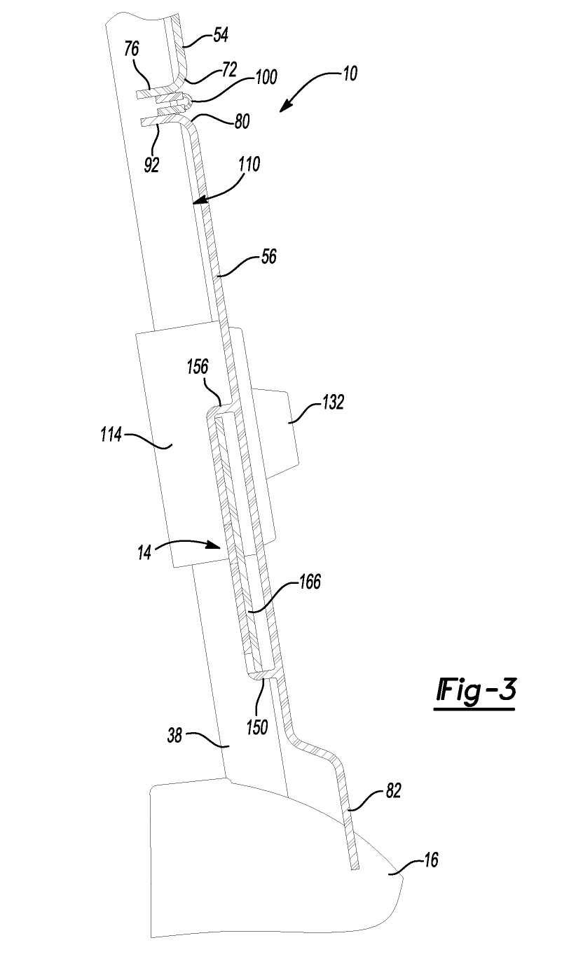

The lower window pane 56 is secured to the window frame 44 and arranged adjacent to the front end 16. In one example, the lower window pane 56 can be secured to the window frame 44 by way of conventional fasteners, not particularly shown, although other fastening arrangements are contemplated. The lower window pane 56 defines a top lateral edge 80, a bottom lateral edge 82, and a pair of side edges 84. A lower portion 88 of the lower window pane 56 defines a stepped section adapted to cooperate with the front end 16 of the golf car 12. As illustrated in FIG. 3, the top lateral edge 80 defines a curved flange 92. The curved flange 92 provides additional structural support to the lower window pane 56.

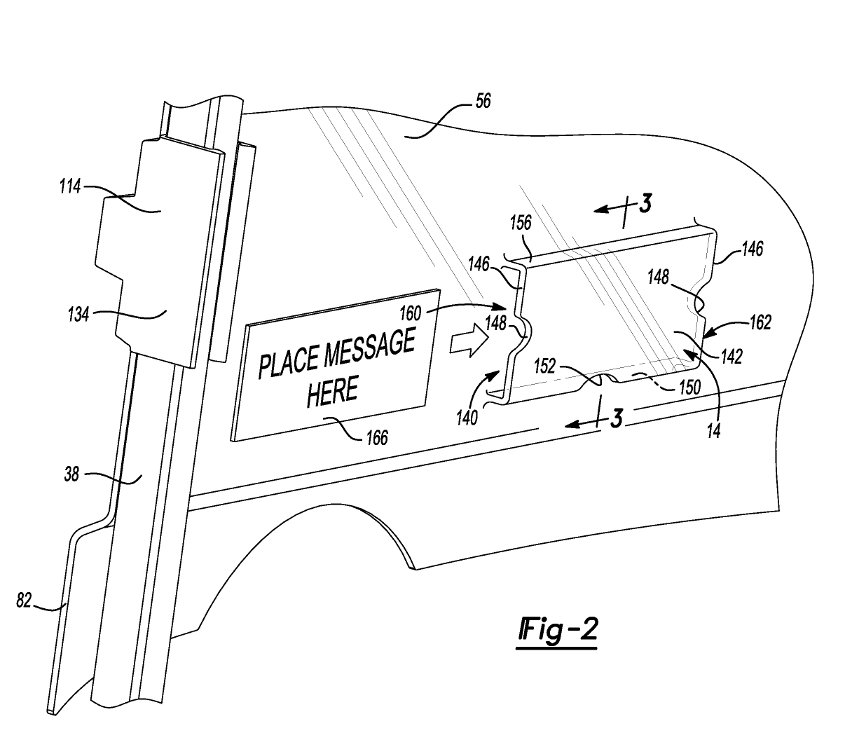

The upper window pane 54 defines a planar section extending between the front struts 38. In an upright position (FIG. 2), the upper window pane 54 is bordered on the top edge 70 by the roof portion 40 (FIG. 1) and bordered on the bottom edge 72 by the lower window pane 56. A flexible coupling member 100 operably connects the upper and lower window panes 54 and 56, respectively. The flexible coupling member 100 is attached to the second end 72 of the upper window pane 54 and the top lateral edge 80 of the lower window pane 56. The curved flanges 92 and 104 each lie inboard of the front struts 38.

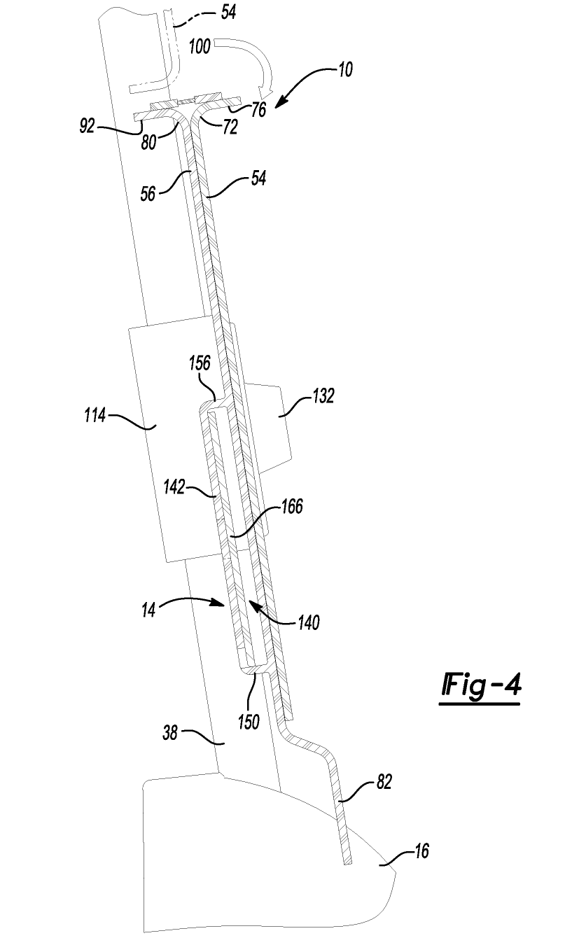

The flexible coupling member 100 is adapted to provide a pivot axis (as viewed in FIGS. 3 and 4) whereby the upper window pane 54 may be moved from the upright position (FIG. 3) to a collapsed position (FIG. 4). The flexible coupling member 100 may be made from a durable resilient material such as rubber. The flexible coupling member 100 may be attached to the upper and lower window panes 54 and 56, respectively, by a press-fit, mechanical fasteners, or chemical bonding for example.

The windshield assembly 10 is supported by the window frame 44. More specifically, the window frame 44 collectively defines a pair of forward mounting surfaces 110. The upper and lower window panes 54 and 60 are configured adjacent to the forward mounting surfaces 110. A first and second pair of retaining members 112 and 114, respectively, are coupled to the front struts 38. The first pair of retaining members 112 generally define a C-shaped body portion including a forward hook portion (not shown) and a rearward hook portion (not shown). The second pair of retaining members 114 can define a body portion including a forward hook portion 132 (FIG. 1), a rearward hook portion 134 and an intermediate finger portion 136. The first and second pair of retaining members 112 and 114, respectively, are operable to securely capture the upper window pane 54 at the upright position (retaining members 112, FIG. 1) and the collapsed position (retaining members 114, not specifically shown).

It is important to recognize that the windshield assembly 10 described herein is merely exemplary and that the message holder 14 may be incorporated on any windshield. Further examples of such windshield assemblies may be found in co-pending U.S. patent application Ser. No. 11/120,869, filed May 3, 2005 entitled, “Three-piece Windshield” which is hereby incorporated by reference.

With reference now to FIG. 2, the message holder 14 will be described in greater detail. The message holder 14 may be integrally formed with the lower window pane 56 in an area generally adjacent to the body 15 of the golf car 12. The message holder 14 generally defines a pocket 140. The pocket 140 can generally include a first transparent portion 142 laterally offset from the lower window pane 56. The first transparent portion 142 defines a pair of parallel, laterally offset terminal edges 146. A pair of cutaway notches 148 can be formed along the terminal edges 146 and extend generally toward each other.

A second transparent portion 150 can extend between the first window pane 56 and the first transparent portion 142. The second transparent portion 150 can be generally transverse to the first window pane 56. Another cutaway portion 152 can be formed between the first and second transparent portions 142 and 150, respectively. A third transparent portion 156 can extend between the lower window pane 56 and the first transparent portion 142. The third transparent portion 156 can be generally parallel to the second transparent portion 150.

The pocket 140 defines a first and a second open end 160 and 162, respectively. As can be appreciated, the pocket 140 of the message holder 14 can be adapted to accept a message 166 through one of a first and a second open ends 160 and 162. The respective cutaway portions 148 are adapted to provide a user access to the message holder 14 and therefore manipulate the message 166 between an installed position and a removed position.

One particular advantage realized by the message holder 14 is shown in FIG. 4. Specifically, the movable window pane (upper window pane 54) of the windshield assembly 10 can be rotated to the collapsed position without interfering with the message holder 14 structurally, and without inhibiting further viewing of the message 166 within the message holder 14. In other words, a user can move the upper window pane 54 between the upright and collapsed positions without having to manipulate around the message holder 14. In addition, the open air passage formed above the lower window pane 54 when the upper window pane 54 is in the collapsed position is generally unimpeded by a downwardly hanging message holder according to prior art arrangements.

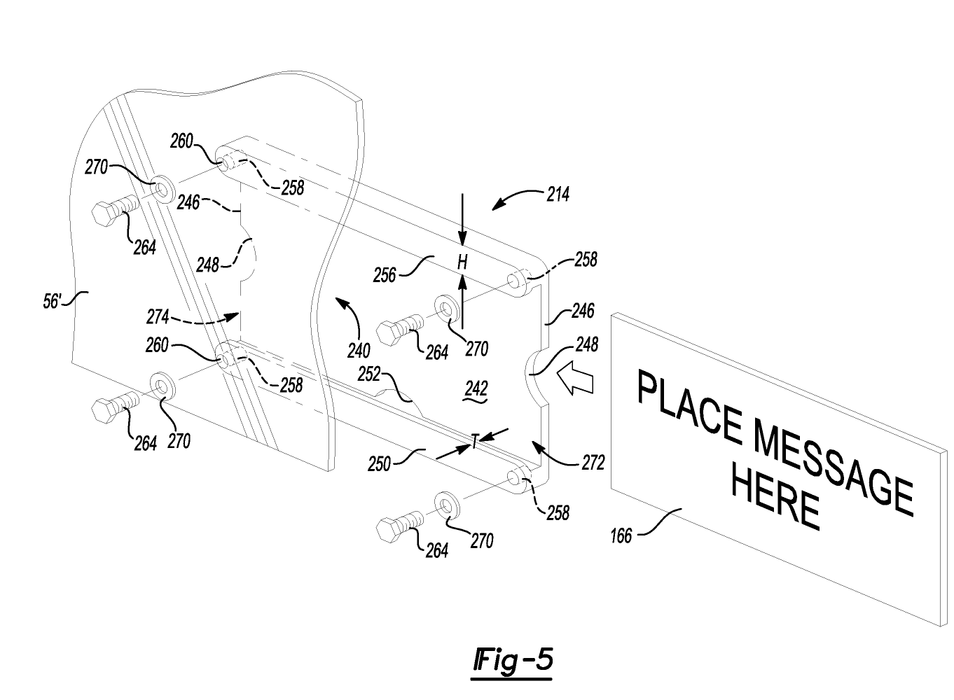

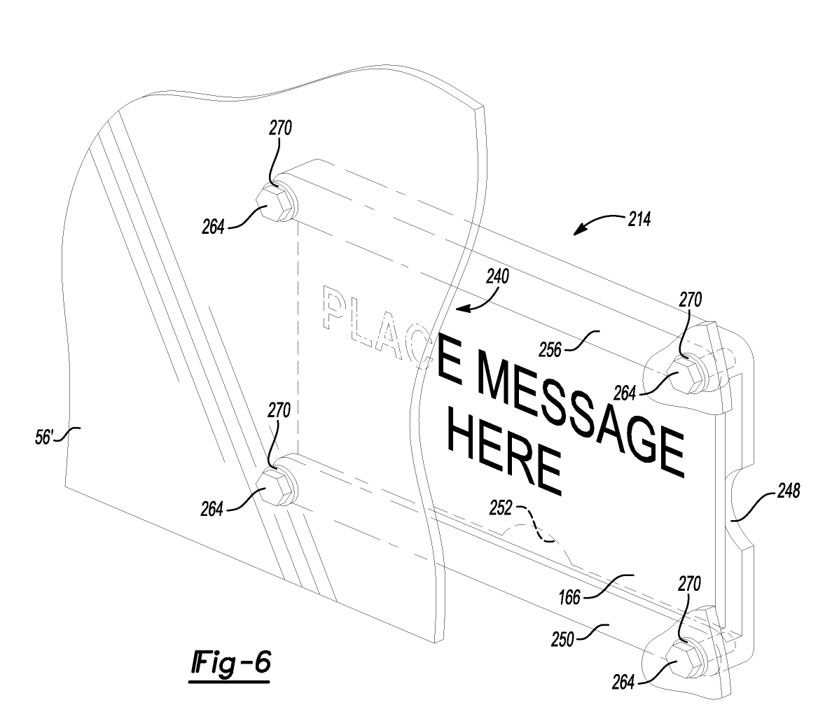

With reference now to FIGS. 5 and 6, a message holder 214 according to additional features will be described. The message holder 214 may be separately formed and fixedly attached to the lower window pane 56′ in an area generally adjacent to the body 15 of the golf car 12 (such as shown in FIG. 1 with respect to the message holder 14). The message holder 214 generally defines a pocket 240. The pocket 240 can generally include a first transparent portion 242 laterally offset from the lower window pane 56′. The first transparent portion 242 defines a pair of parallel, laterally offset terminal edges 246. A pair of cutaway notches 248 can be formed along the terminal edges 246 and extend generally toward each other.

A second transparent portion 250 can extend between the first window pane 56′ and the first transparent portion 242. The second transparent portion 250 can be generally transverse to the first window pane 56′. Another cutaway portion 252 can be formed at a transition between the first and second transparent portions 242 and 250. A third transparent portion 256 can extend between the lower window pane 56′ and the first transparent portion 242. The third transparent portion 256 can be generally parallel to the second transparent portion 250. The second and third transparent portions 250 and 256 define a height H and a thickness T. A series of apertures 258 can be formed through the second and third transparent portions 250 and 252, respectively. A complementary series of apertures 260 can be formed through the lower window pane 56′. Fasteners 264 can be adapted to extend through the respective apertures 258 and 260 to fixedly secure the message holder 214 to the lower window pane 56′. Washers 270 may also be used. It is appreciated that the message holder 214 can be secured to the lower window pane 56′ by other methods. In another example, not shown, the message holder 214 can be secured to the lower window pane 56′ exclusively or additionally by adhesive.

The pocket 240 defines a first and a second open end 272 and 274. As can be appreciated, the pocket 240 of the message holder 214 can be adapted to accept a message 166 through one of the first and second open ends 272 and 274. The respective cutaway portions 248 and 252 are adapted to provide a user access to the message holder 214 and therefore manipulate the message 166 between an installed position and a removed position.

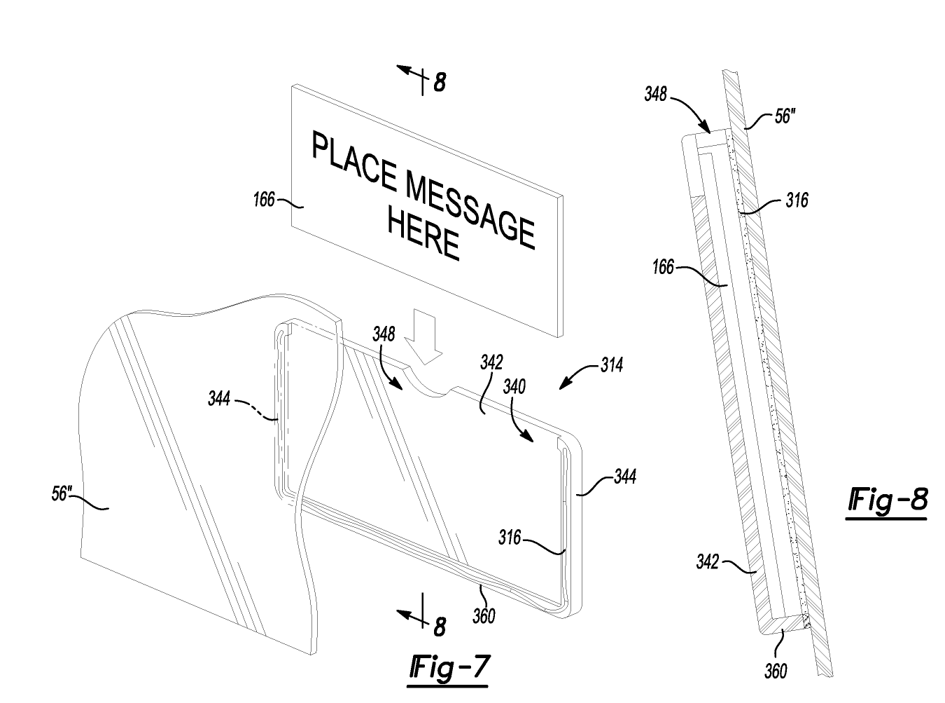

With reference now to FIGS. 7 and 8, a message holder 314 according to additional features will be described. The message holder 314 may be separately formed and fixedly attached to the lower window pane 56″ by adhesive 316. As with the other message holders 14 and 214, the message holder 314 is located in an area generally adjacent to the body 15 of the golf car 12 (such as shown in FIG. 1 with respect to the message holder 14). The message holder 314 generally defines a pocket 340. The pocket 340 can generally include a first transparent portion 342 laterally offset from the lower window pane 56″.

A second transparent portion 360 can extend between the first window pane 56″ and the first transparent portion 342. The message holder 314 defines a pair of generally vertical, laterally displaced transparent portions 344. In this way, the pocket 340 defines an opening 348 on an upper end of the message holder 314 for dropping the message 166 vertically downward and removing the message 166 vertically upward.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, the specification and the following claims.

What is claimed is:

1. A window assembly cooperating with a window frame on a golf car, the window assembly comprising:
a first window pane selectively coupled to the window frame and defining a lower portion arranged adjacent to a body of the golf car; and
a message holder disposed on the lower portion of the first window pane, the message holder being integrally formed with the first window pane and adapted to removably accept a message therein.

2. The window assembly of claim 1 wherein the message holder defines a pocket having at least one open end.

3. The window assembly of claim 2 wherein the pocket defines a first transparent portion laterally offset from the first window pane.

4. The window assembly of claim 3 wherein the first transparent portion further defines a pair of parallel laterally offset terminal edges.

5. The window assembly of claim 4 wherein at least one of the offset terminal edges defines a first cutaway notch extending generally toward the other of the terminal edges.

6. The window assembly of claim 3 wherein the pocket defines a second transparent portion extending between the first window pane and the first transparent portion, the second transparent portion being generally transverse to the first window pane.

7. The window assembly of claim 6 wherein the pocket further comprises a third transparent portion extending between the first window portion and the first transparent portion, the third transparent portion being generally parallel to the second transparent portion.

8. The window assembly of claim 6 wherein a second cutaway notch is formed between the first and second transparent portions.

9. The window assembly of claim 1, further comprising a second window pane selectively coupled to the window frame and offset from the first window pane in a direction away from the body of the golf car.

10. A window assembly cooperating with a window frame on a golf car, the window assembly comprising:
a first window pane selectively coupled to the window frame and defining a lower portion arranged adjacent to a body of the golf car; and
a message holder disposed on the lower portion of the first window pane, the message holder being fixedly coupled to the first window pane and adapted to removably accept a message therein.

11. The window assembly of claim 10 wherein the message holder is fixedly coupled to the first window portion by one of fasteners, molding, or gluing.

12. The window assembly of claim 11 wherein the message holder defines a pocket having at least one open end.

13. The window assembly of claim 12 wherein the pocket defines a first transparent portion laterally offset from the first window pane.

14. The window assembly of claim 13 wherein the first transparent portion further defines a pair of parallel laterally offset terminal edges.

15. The window assembly of claim 14 wherein at least one of the offset terminal edges defines a first cutaway notch extending generally toward the other of the terminal edges.

16. The window assembly of claim 13 wherein the pocket defines a second transparent portion extending between the first window pane and the first transparent portion, the second transparent portion being generally transverse to the first window pane.

17. The window assembly of claim 16 wherein the pocket further comprises a third transparent portion extending between the first window portion and the first transparent portion, the third transparent portion being generally parallel to the second transparent portion.

18. The window assembly of claim 10, further comprising a second window pane selectively coupled to the window frame and offset from the first window pane in a direction away from the body of the golf car.

19. A window assembly cooperating with a window frame on a golf car, the window assembly comprising:
a first window pane selectively coupled to the window frame and defining a lower portion arranged adjacent to a body of the golf car; and
a message holder defining a first transparent portion laterally offset from the first window pane and a pair of laterally offset transparent portions extending from the first transparent portion in a generally vertical direction, wherein the message holder is adhesively secured on the lower portion of the first window pane, the message holder defining an upper open end adapted to removably accept a message therein.

20. The window assembly of claim 19 wherein the first transparent portion defines a first cutaway notch formed at the upper open end.
